(19) United States
(12) Patent Application Publication
(10) Pub. No.: US 2004/0224066 A1
(43) Pub. Date: Nov. 11, 2004

(54) Method for suppressing acrylamide formation

(76) Inventors: Robert C. Lindsay, Madison, WI (US); Sungjoon Jang, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/787,599

(22) Filed: Feb. 26, 2004

Related U.S. Application Data
(60) Provisional application No. 60/450,445, filed on Feb. 26, 2003.

(51) Int. Cl. A23L 1/00

(52) U.S. Cl. 426/520

(57) ABSTRACT

Acrylamide formation in a food material can be suppressed by water-blanching the food material at a suitable temperature for a sufficient period of time as specified herein, or by treating the food material with an acrylamide-formation suppressing agent disclosed herein. In the water-blanching method, suitable blanching temperatures range from about 45° C. to about 78° C., and suitable blanching time is a time period of over 4 minutes. The acrylamide-formation suppressing agent that can employed to suppress acrylamide formation include a multivalent cation, a chelating compound, a carbonyl group blocker, and a combination of any of the foregoing. The water-blanching method is applicable to food materials having essentially intact cellular and tissue structures. The method employing an acrylamide-formation suppressing agent applies to all food materials either with or without intact cellular and tissue structures.

### CROSS-REFERENCE TO RELATED APPLICATIONS

This application claims the benefit of U.S. provisional patent application Serial No. 60/450,445, filed on Feb. 26, 2003.

### STATEMENT REGARDING FEDERALLY SPONSORED RESEARCH OR DEVELOPMENT

Not applicable.

### BACKGROUND OF THE INVENTION

The formation of acrylamide, a neurotoxin suspected to be a carcinogen in humans, has been noted in certain cooked foods after uncooked foods are heated to high temperatures (at or above about 100° C.). Various formation mechanisms may be at work. It has been reported that asparagine in the foods, as well as other amino acids, can react with sugars via the Maillard reaction. While the Maillard reaction adds taste, aroma, and color to the cooked foods, it also yields acrylamide. As the major acrylamide formation pathway in food materials and products, a reducing sugar such as glucose and asparagine undergo carbonyl-amine condensation and the resultant condensation product dehydrates to form N-glucosylasparagine (FIG. 1). N-glucosylasparagine then undergoes decarboxylation and various other steps to generate acrylamide (FIG. 1).

The foods most susceptible to acrylamide formation during high temperature processing or cooking are foods that contain high levels of sugar/reducing sugar, high levels of starch (a source of glucose), high levels of free asparagine or a combination of any of the foregoing. These foods include, but are not limited to, potatoes, sweet potatoes, grains, asparagus, onions, bananas, nuts (e.g., almond nuts) and food products made from these foods. Large-scale processing methods for these foods and food products are known and typically include peeling the raw food matter, cutting the peeled matter into pieces of suitable sizes, optionally blanching the pieces in hot water and then cooling in cold water (fluming).

Vegetables and fruits are routinely blanched at 80° C. to 100° C. for the purpose of exhausting gasses from the tissues, thermally inactivating enzymes that cause off-flavors or off-colors, and thermally inactivating some vegetative cells of microorganisms. Blanching of potatoes is practiced mainly to thermally inactivate polyphenoloxidase for whitening potato tissue by preventing the formation of enzymatic blackening pigments. Such blanching is commonly accomplished at temperatures of 80° C. to 82° C. with hold times of 2 to 4 minutes. Lower blanching temperatures (i.e., below 80° C.) are avoided because of incomplete inactivation of polyphenoloxidase. It is also common to flume (transport, cool, and soak) blanched French fry strips in aqueous solutions at ambient temperatures for a few minutes up to one hour. A sugar is typically included in the fluming solution in order to provide the best color on potato pieces upon frying. Additionally, the pieces can be partially fried (“par-fried”) and/or frozen before being prepared for consumption by frying or baking. The general processes for potato processing are described in Potato Processing, Talburt, Van Nostrand, New York, 4^{th} Ed., W. F. and O. Smith, eds. (1987), incorporated by reference herein as if set forth in its entirety. Additional general processes for processing potatoes and other food materials are known to the skilled artisan.

It is evident that the conventional food processing methods are not adequate to control acrylamide formation on heating to high temperatures. The art is desirous of convenient modifications to the conventional methods to reduce or prevent acrylamide formation during processing and preparation.

### BRIEF SUMMARY OF THE INVENTION

It is disclosed here that acrylamide formation in a food material can be suppressed by water-blanching the food material at a suitable temperature for a sufficient period of time as specified herein, or by treating the food material with an acrylamide-formation suppressing agent disclosed herein. In the water-blanching method, suitable blanching temperatures range from about 45° C. to about 78° C., and suitable blanching time is a time period of over 4 minutes. The acrylamide-formation suppressing agents that can be employed to suppress acrylamide formation include a multivalent cation, a chelating compound, a carbonyl group blocker, and a combination of any of the foregoing. The water-blanching method is applicable to food materials having essentially intact cellular and tissue structures. The method employing an acrylamide-formation suppressing agent applies to all food materials either with or without intact cellular and tissue structures.

In one aspect, the present invention relates to a method of preparing a food material for high temperature heating in order to reduce acrylamide formation in the food material when it is heated to high temperatures. The method involves water-blanching the food material as described above and/or exposing the food material to an acrylamide suppressing agent in an amount effective to suppress acrylamide formation. A food material treated according to the method is also within the scope of the invention.

In another aspect, the present invention relates to a method of making a food product from a food material. The method involves water-blanching the food material and/or exposing the food material to an acrylamide suppressing agent as described above, and heating the food material at a high temperature. The food product made by the method is also within the scope of the present invention.

It is an object of the present invention to provide a method for suppressing acrylamide formation in a food material when the food material is heat-processed at high temperatures.

It is an advantage of the present invention that many natural compounds can be used in the method to suppress acrylamide formation.

It is another advantage of the present invention that the methods disclosed here can be practiced without sophisticated machinery.

It is still another advantage of the present invention that the methods disclosed here can often be practiced by modifying an existing step of a food processing process.

Other objects, advantages and features of the present invention will become apparent from the following specification.

### BRIEF DESCRIPTION OF THE SEVERAL VIEWS OF THE DRAWINGS

FIG. 1 shows a major acrylamide formation pathway in food materials.

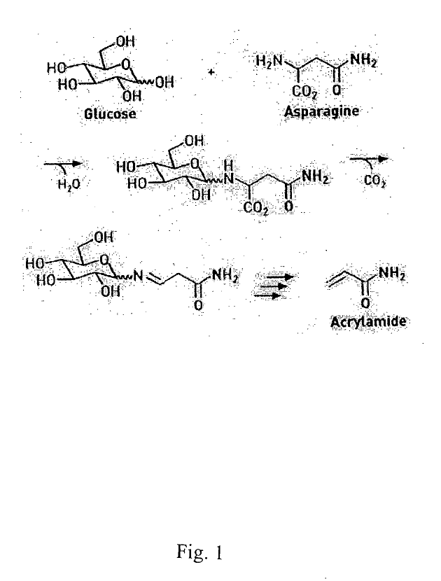

### DETAILED DESCRIPTION OF THE INVENTION

It is disclosed here that for any food preparation process that involves a high temperature heating step, the acrylamide level in the final food product can be reduced by treating an intermediate food material with an acrylamide-formation suppressing agent disclosed herein before the high temperature heating step. It is further disclosed that for a food material having essentially intact cellular and tissue structures, water-blanching the material at a suitable temperature for a sufficient period of time before the high temperature heating step can also reduce the acrylamide level in the final food product. Without intending to be limited by theory and as further detailed below, the inventors believe that the particular water-blanching conditions disclosed herein, in terms of blanching temperature and time, induce the formation of an acrylamide suppressing agent in the food material which can suppress acrylamide formation in a subsequent high temperature heating step. Using various acrylamide-formation suppressing agents and the typical potato processing and cooking procedures for making French fries and potato chips, the inventors demonstrated in the examples below that treating food materials according to the present invention lowered acrylamide levels in the final food products. Preferably, the acrylamide suppressing methods disclosed herein reduce the acrylamide level in a final food product by at least 40%, 50%, 60%, 70%, 80%, 90% or 95%.

By high temperature heating, we mean exposing the food material to a temperature of at least 100° C., 120° C., 150° C., 180° C. or 190° C. Examples of high heating in a food preparation process include but are not limited to frying, baking, roasting, steaming, boiling and high temperature extrusion. The present invention can be practiced with any food material (including animal food material) the heating of which at a high temperature can lead to the formation of acrylamide. Examples of such food materials include but are not limited to those that contain starch, high levels of free asparagine or both. A food material that contains starch is referred to as starchy-food material and the food products prepared therefrom are referred to as starchy-food. Examples of starchy-food include but are not limited to those prepared from potato or potato-based materials, sweet potato or sweet potato-based materials, grain (e.g., wheat, oat, rye, corn and rice) or grain-based materials, and meat products that contain starch (e.g., hamburger and fried chicken). Representative food products that are made of potatoes include French fries and potato chips. In addition, potatoes, sweet potatoes, grains and the like are often processed into doughs, batters and mash. From these doughs, batters and mash, products such as crackers, breads, quick-breads, cookies, chips, breakfast cereals and the like can be produced, as can deep-fried foods and extruded foods, such as snack foods.

By acrylamide-formation suppressing agent, which is used interchangeably with the term “acrylamide suppressing agent,” we mean one of the following: (1) a multivalent cation, (2) a chelating compound, (3) a carbonyl group blocker, and (4) a combination of any of the foregoing.

Examples of suitable multivalent cations that can be employed in the present invention to suppress acrylamide formation include but are not limited to calcium, magnesium, iron, aluminum, and barium cations, which are preferably provided as a chloride, sulfate, phosphate or carbonate salt. Mixtures of various cations are also within the scope of the invention.

For the purpose of the present invention, a chelating compound is defined as a compound that has a polyanionic structure and at least one additional electron-rich atom such as an oxygen or nitrogen atom. The polyanionic structure provides negatively charged groups when ionized so that the chelating compound can form a complex with an acrylamide precursor (e.g., asparagine or N-glucosylasparagine) in a food material, a multivalent cation added to the food material according to the present invention, or both. Carboxyl groups and various phosphate groups (e.g., mono-, di-, tri- and poly-phosphate groups) are examples of negatively charged groups that can be provided on a chelating compound. The additional electron-rich atom on a chelating compound is positioned on the compound to provide coordinating electrons for stabilizing the complex formed between the chelating compound and the acrylamide precursor or the multivalent cation. Preferably, a chelating compound of the present invention has a molecular stereogeometry favorable to the formation of a basket-like, shielding inclusion structure. Examples of the chelating compounds as defined herein include but are not limited to phytate, phytic acid, pectin (including high and low methylester pectins, also referred to as high or low methoxyl pectins in the art ), pectate, pectic acid, pectinate, pectinic acid, alginate (e.g., alginate salts such as sodium alginate, and propylene glycol alginate), alginic acid, sodium carboxymethyl cellulose (CMC), EDTA, citric acid, and condensed phosphates such as sodium acid pyrophosphate (SAPP) and hexametaphosphate. Among the above chelating compounds, phytate, phytic acid, pectin, pectate, pectic acid, pectinate, pectinic acid, alginate and alginic acid are preferred because of their tendency to form insoluble complexes with acrylamide precursors and multivalent cations. When pectin is used, low methylester pectins are preferred over high methylester pectins. It is noted that a chelating compound may not need to be purified from a source for use in the present invention. For example, corn steep liquor that is rich in phytic acid can be used directly to suppress acrylamide formation.

Without intending to be limited by theory, the inventors believe that the multivalent cation and the chelating compounds disclosed herein suppress acrylamide formation by forming complexes with one or more acrylamide precursors to prevent the precursors from further participating in the acrylamide-formation reactions. Depending on the chelating compounds, the formation of the complexes may also lower the solubility of the acrylamide precursors and thereby further prevent them from participating in acrylamide-formation reactions. When a multivalent cation and a chelating compound are used together, more complicated complexes such as “chelating compound-multivalent cation-acrylamide precursor” complexes (e.g., “chelating compound-multivalent cation-asparagine” complexes and “chelating compound-multivalent cation-N-glucosylasparagine” complexes) can also form to prevent acrylamide formation.

In a discovery believed to be related to the above, the inventors found that blanching potato strips in water alone could reduce the acrylamide level in French fries provided that the blanching step was conducted at a temperature somewhat lower than the typical 80° C. to 82° C. blanching temperature and for a period of time longer than the typical blanching time of 2 to 4 minutes. It is theorized that under such blanching conditions, the blanching temperature is sufficiently high to cause enough thermal damage to cells so that the enzyme pectin methyl esterase leaks from its protected, compartmentalized site, but not high enough to cause rapid thermal inactivation of the enzyme. The released pectin methyl esterase can hydrolyze methyl alcohol from the methyl ester groups on the pectin molecules to yield free carboxyl groups on the pectin for complexing with acrylamide precursors either by itself or through a multivalent cation. Since it takes time for the pectin methyl esterase to be released, to find the pectin substrate and to catalyze the formation of free carboxyl groups on the pectin molecules, the longer than usual blanching time is necessary for the purpose of suppressing acrylamide formation. Given the lower than usual blanching temperature, the longer than usual blanching time is also necessary to inactivate polyphenoloxidase in order to prevent greying or blackening caused by the enzyme in the finished potato products. In addition, it is believed that the lower than usual blanching temperature prevents substantial starch degradation associated with high temperature blanching conducted at 80° C. and above. Starch degradation increases the amount of glucose available for acrylamide formation. Generally speaking, the blanching temperature employed in the water-blanching method disclosed herein for suppressing acrylamide formation should be from about 45° C. to about 78° C. or 50° C. to about 78° C., preferably from about 60° C. to about 75° C. and more preferably at about 70° C., and the blanching time should be 4 minutes or longer, preferably from about 5 minutes to about 120 minutes or from about 10 minutes to about 90 minutes, more preferably from about 30 minutes to about 60 minutes and most preferably about 30 minutes. It is expected that the water-blanching method can be applied to all food materials with essentially intact cellular and tissue structures to suppress acrylamide formation.

The carbonyl group blockers disclosed herein as acrylamide suppressing agents are believed to suppress acrylamide formation by competing with asparagine for condensing with reducing sugars in a food material. By definition, the condensation products between carbonyl group blockers and reducing sugars do not proceed to form acrylamide and they do not readily degrade or accelerate overall browning reactions with the formation of additional carbonyl compounds either. Carbonyl group blockers are well known in the art. Examples of carbonyl group blockers include but are not limited to chitosan, lysine, cysteine and acetylcysteine. Preferably, a natural carbonyl group blocker such as chitosan is used in the present invention.

In one aspect, the present invention relates to a method of preparing a food material with essentially intact cellular and tissue structures for a high temperature heating step in order to reduce acrylamide formation while being processed at high temperatures. The method involves blanching the food material in water at a temperature from about 45° C. to about 78° C. for over 4 minutes. Preferably, the food material is blanched at about 50° C. to about 78° C. or about 60° C. to about 75° C., and more preferably at about 70° C. The blanching time is preferably longer than 4 minutes, from about 5 minutes to about 120 minutes or from about 10 minutes to about 90 minutes, more preferably from about 30 minutes to about 60 minutes, and most preferably about 30 minutes. For a food processing process that already involves a blanching step, such as the process for making French fries and processing various vegetables, the method of the present invention is combined with the existing blanching step with the blanching temperature and blanching time adjusted according to those disclosed here for effectively suppressing the acrylamide formation. For a food processing process which does not involve a blanching step, the method disclosed here can be practiced as an additional step in the food processing process.

In another aspect, the present invention relates to a method of preparing a food material for a high temperature heating step in order to reduce acrylamide formation while being processed at high temperatures. The method involves exposing the food material to an acrylamide suppressing agent prior to subjecting the food material to the high temperature heating step in an amount effective to suppress the acrylamide formation. Two or more acrylamide suppressing agents can be combined for optimal effect. For example, a multivalent cation and a chelating compound can be used together to maximize complex formation between acrylamide precursors and acrylamide suppressing agents for preventing the precursors from being converted to acrylamide.

In one embodiment of this aspect of the invention, the method is practiced with a food material having essentially intact cellular and tissue structures. Examples of such food materials include but are not limited to cut or sliced potatoes for making French fries and potato chips, cut or sliced sweet potatoes for making fried sweet potato products, various raw nuts (e.g., almond nuts) for making roasted nuts, and various cut vegetables. In this embodiment, the acrylamide suppressing agent is provided in a solution such as an aqueous solution to treat the food material. For chelating compounds in particular, smaller compounds such as phytate and phytic acid are preferred over larger compounds such as pectin and alginate because smaller chelating compounds can pass through the cellular membrane more easily. In order to facilitate the entry of the agents into cells, salts such as NaCl can be optionally provided in the solution, preferably in a concentration from about 0.5% to about 10% or from about 1.5% to about 5%, to make the cellular membrane more porous. For any particular application of the invention, the full range of the effective amounts of an acrylamide suppressing agent and the full range of the effective treatment times can be readily determined by a skilled artisan through routine experimentation. Generally speaking, multivalent cation(s) can be provided in a solution from about 125 ppm to about 10,000 ppm, from about 250 ppm to about 5,000 ppm, from about 250 ppm to about 3,000 ppm, or from about 250 ppm to about 1,000 ppm; chelating compound(s) can be provided in a solution from about 125 ppm to about 10,000 ppm, from about 250 ppm to about 5000 ppm, from about 250 ppm to about 3000 ppm, or from about 250 ppm to about 1,000 ppm; and carbonyl group blocker(s) can be provided in a solution from about 50 ppm to about 10,000 ppm, from about 125 ppm to about 5,000, from about 125 ppm to about 3,000, or from about 250 ppm to about 1,000 ppm. Preferred treatment time is 30 seconds or longer, 1 minute or longer, 4 minutes or longer, from about 5 minutes to about 120 minutes, from about 10 minutes to about 90 minutes, or from about 30 minutes to about 60 minutes.

It is preferred that when acrylamide suppressing agents are provided in solutions to treat food materials, the temperatures and treatment times described in connection with the water-blanching method are used for optimal effects, especially when only one agent is employed to suppress acrylamide formation.

Another factor that can affect the efficacy of an acrylamide suppressing agent in a solution is the pH value of the solution. For example, a high pH value favors carbonyl-amino condensation between glucose and asparagine by increasing the availability of the amino group and it also accelerates the decarboxylation reaction that yields acrylamide. Therefore, the solution used to treat a food material should have a pH value of less than 7 in order to achieve optimal results. Furthermore, acidic conditions are required for some agents such as phytate to be dissolved into the solution. However, too low of a pH leads to starch degradation and thus increases the amount of glucose available for acrylamide formation. Too low of a pH also gives the food an unpleasant sour taste. Accordingly, the pH value of the solution for treating a food material should be controlled to a certain range. Generally speaking, the pH value of the solution should be from about 1.8 to about 6.8, preferably from about 2.2 to about 6.5, more preferably from about 2.75 to about 5.5 and most preferably about 3.0 to about 4.0. In addition, the solution is preferred not to be buffered so that once the solution is in contact with the food material, the food material can raise the pH value of the solution (e.g., to about 6.5 or 6.8) to minimize the souring effect of the solution on the food material.

It is appreciated that in this embodiment of the method in which an acrylamide suppressing agent is applied to a food material having essentially intact cellular and tissue structures, the method can be practiced with a food processing process as an independent step or in combination with an existing food processing step. For example, when the method is practiced in connection with the production of French fries, the washed and cut potatoes can be treated with an acrylamide suppressing agent after they have been blanched or flumed, or they can be treated with the agent while being blanched, flumed or both by including the agent in the blanching and fluming solutions. Preferably, if a food processing process already involves a blanching step, the method is combined with the blanching step using the blanching conditions described herein in connection with the water-blanching method of the present invention.

In another embodiment, the present invention is practiced in connection with food materials in which the cellular and tissue structures are dismantled. Examples of such food materials include potato-, sweet potato- and grain-based doughs, batters and mash for making particulate food products. General compositional information and fabrication technology methods involving doughs and batters are described in Fabricated Foods, Avi Publishing Co., Inglett, G. E., ed. (1975), incorporated by reference as if set forth herein in its entirety. In this embodiment, an acrylamide suppressing agent can be added and mixed with the food material in the form of a solid. Alternatively, the acrylamide suppressing agent can be provided in a concentrated solution and mixed with the food material. Since the cellular and tissue structures are dismantled in these food materials, relatively large chelating compounds such as pectin and alginate can be readily used free of any concern on their ability to enter into cells. Generally speaking, when mixed with a food material, the final concentration of the multivalent cation, the chelating compound, and the carbonyl group blocker should each range from about 0.01% to about 5% by weight or from about 0.1% to about 1% by weight. Other effective amounts of the acrylamide suppressing agents can be readily determined by a skilled artisan through routine experimentation.

In another aspect, the present invention relates to a method of making a food product from a food material. The method involves water-blanching the food material and/or exposing the food material to an acrylamide suppressing agent as described above, and heating the food material at a high temperature. The food product made by the method such as par-fried French fries and fully-cooked French fries and potato chips are within the scope of the present invention.

The following examples are given to further illustrate the present invention. The present invention is not limited to the specific details set forth in the examples.

### EXAMPLE 1

### Acrylamide Analysis

Acrylamide extraction: Food material samples (2-10 g each) were placed into 100 g of distilled water containing 1.0 μg of 1,2,3 ¹³C-acrylamide as internal standard (Cambridge Isotope Laboratories, Inc.) Each sample was rehydrated for about 10 min at ambient temperature, and then blended thoroughly with a probe homogenizer for extraction of acrylamide. The upper clear layer of water extract was transferred to a 50 ml of disposable centrifuge tube, and then centrifuged at 3,820×g for 20 min at 5.0° C. After centrifugation, the upper lipid layer was manually removed, and then about 50 ml of extract was transferred into a 200-ml glass-stoppered flask for bromine derivatization.

Bromine Derivatization (Followed US EPA bromination method #8032A): For each sample extract, 7.5 g of KBr was dissolved into the sample extract, and the solution was adjusted with concentrated HBr (40 wt % in H₂O) to between pH 1 and 3. The solution pH of each sample was verified with pH paper (EM Science, Gibbstown, N.J.). Each sample flask was wrapped with aluminum foil, and 2.5 ml of saturated bromine water reagent was added, tightly covered with glass-stopper, and then placed in a dark room for the bromination reaction to proceed at 5.0° C. for at least 1 hour. After reaction completion, the excess amount of bromine reagent was decomposed by adding 1.0 M sodium thiosulfate drop-wise until the solution became colorless. Next, 15 g of sodium sulfate was added into each sample flask with vigorous shaking, and the solution was then extracted with 25 ml ethylacetate. The upper organic layer of ethylacetate was transferred to a glass tube, which was then placed in a water bath (40° C.) for concentration to about 0.5 ml under a slow stream of nitrogen for GC-MS analysis.

Instrumental Specification and Identification: Acrylamide analyses were performed with a Hewlett-Packard 6890 series GC system with Agilent 7683 series injector and Agilent 5973 Network Mass Selective Detector. Separation parameters included the use of a DB-17 column (30 m×0.25 mm i.d.), and the GC was programmed from 65° C. to 215° C. with a rate of 15° C./min, and then to 235° C. with a rate of 2° C./min at which point it was held for 2 min. Injector and detector temperatures were both at 250° C. The selective ion monitoring mode was used for identification of brominated acrylamide. The selected ions included mass 150, 152, and 106 for analyte acrylamide, and 155, 153, and 110 for the internal standard (1,2,3 ¹³C-acrylamide). For quantification, ion masses of 150 for acrylamide and 155 for the internal standard were used.

### EXAMPLE 2

### Reducing Acrylamide Formation in Potato Chips

General procedure for making fried potato chips—Potatoes (commercial chip potato variety) were peeled and cut into 1.5 mm thick chips with a Hobart slicer. The cut potatoes were blanched at 80° C. for 1 minute in water (control) or indicated solutions, or at 70° C. for 30 minutes in water (control) or indicated solutions. Next, the cut potatoes were rinsed at about 21° C. for 1 minute in water (control) or indicated solutions by immersing the cut potatoes in water or indicated solutions. Next, the cut potatoes were fried in commercial partially hydrogenated vegetable oil at 177° C. or 180° C. for about 2 minutes or until steam bubbles ceased. Any variation from the procedure described here are indicated in the tables.

General procedure for making fried sweet potato chips—Sweet potatoes (commercial sweet potato variety) were peeled and cut into 1.5 mm thick chips with a Hobart slicer. The cut potatoes were blanched at 70° C. for 30 minutes in water (control) or indicated solutions. Next, the cut potatoes were rinsed at about 21° C. for 1 minute in water (control) or indicated solutions by immersing the cut potatoes in water or indicated solutions. Next, the cut potatoes were fried in commercial partially hydrogenated vegetable oil at 180° C. for about 2 minutes or until steam bubbles ceased. Any variation from the procedure described here are indicated in the tables.

Chitosan solution preparation—A 1% stock solution was prepared by adding commercial chitosan powder (5.0 g; crustacean origin) into 495 g of 10% acetic acid prepared in deioninzed water. The chitosan powder suspension was stirred with a magnetic stirring bar until it was dispersed in solution (became transparent). This process usually took about 3 hrs at 21° C. Appropriate amounts of this stock solution were added to aqueous treatment solutions for application. Diluted treatment solutions were used without further adjustments with regard to the dissolved chitosan component.

Results—Table 1 shows that water-blanching cut potatoes before frying under the conditions provided in the present invention reduced acrylamide level in potato chips.

Table 2 shows that treating cut potatoes with CaCl₂ before frying under the conditions provided in the present invention reduced acrylamide level in potato chips.

Table 3 shows that treating cut sweet potatoes with CaCl₂ and NaCl before frying under the conditions provided in the present invention reduced acrylamide level in sweet potato chips.

Table 4 shows that treating cut potatoes with CaCl₂ and phytate before frying under the conditions provided in the present invention reduced acrylamide levels in potato chips.

Table 5 shows that treating cut potatoes with chitosan before frying under the conditions provided in the present invention reduced acrylamide level in potato chips.

Table 6 shows that treating cut potatoes with CaCl₂ and chitosan before frying under the conditions provided in the present invention reduced acrylamide levels in potato chips.

TABLE 1

| | Acrylamide | Reduction |
|---|---|---|
| Potato Chip | Concentration | (% versus |
| Sample^{a} Treatment | (μg/kg; ppb) | Untreated) |
| Untreated Control | 661 | — |
| cut, wash | | |
| soak in deionized water at 21° C. | | |
| for 30 min | | |
| fry^{b} | | |
| Treated | 59 | 91 |
| cut, wash | | |
| 70° C. for 30 min dionized water | | |
| cool in deionized 21° C. water | | |
| for 1 min | | |
| fry^{b} | | |

^{a}Prepared with a commercial potato chip variety.
^{b}Chips were cut 1.5 mm thick with Hobart slicer, and then washed (about 1 min) in excess (about 20:1) water at ambient temperature (about 21° C.). After removing and draining, the chips were fried at about 180° C. (355° F.) in food service partially hydrogenated vegetable oil until steam bubbles ceased (about 2 min).

TABLE 2

| | Acrylamide | |
|---|---|---|
| Potato Chip | Concentration | Reduction |
| Sample^{a} Treatment | (pg/kg; ppb) | (% versus Untreated) |
| Untreated | 421 | — |
| cut, wash and fry^{b} | | |
| Treated | 102 | 76 |
| cut, wash | | |
| after washing, 1 min | | |
| tempering at 70° C., then | | |
| held at 70° C. in 1000 ppm | | |
| CaCl2 for 30 min; then | | |
| rinsed with ambient | | |
| (21° C.) deionized water | | |

^{a}Prepared with a commercial potato chip variety.
^{b}Chips were cut 1.5 mm thick with Hobart slicer, and then washed (about 1 min) in excess (about 20:1) water at ambient temperature (about 21° C.). After removing and draining, the chips were fried at about 180° C. (355° F.) in food service partially hydrogenated vegetable oil until steam bubbles ceased (about 2 min).

TABLE 3

| | | Reduction |
|---|---|---|
| Sweet Potato Chip | Acrylamide Concentration | (% versus |
| Sample^{a} Treatment | (pg/kg; ppb) | Untreated) |
| Untreated | 5039 | — |
| cut, wash & fry^{b} | | |
| Treated | 95 | 98 |
| cut, and wash | | |
| wash preheat 1 min at | | |
| 70° C. in HOH, then held | | |
| in 1000 ppm Ca⁺⁺ and | | |
| 1.5% NaCl at 70° C. for 30 | | |
| min, then 1 min rinse in | | |
| deionized water before | | |
| frying | | |

^{a}Prepared with a fresh, retail, commercial sweet potato variety.
^{b}Chips were cut 1.5 mm thick with Hobart slicer, and then washed (about 1 min) in excess (about 20:1) deionized water at ambient temperature (about 21° C.). After removing and draining, the chips were fried at about 180° C. (355° F.) in food service partially hydrogenated vegetable oil until steam bubbles ceased (about 2 min).

TABLE 4

| | Acrylamide | Reduction |
|---|---|---|
| Potato Chip | Concentration | (% versus |
| Sample^{a} Treatment | (μg/kg; ppb) | Untreated) |
| Untreated Control | 1064 | — |
| cut, wash & fry^{b} | | |
| Treated | 78 | 93 |
| cut, wash | | |
| blanched with water and flumed | | |
| with 250 ppm phytate + 1000 ppm | | |
| CaCl₂ + pH 3.1 with HCl | | |
| fry^{b} | | |
| Treated | 25 | 98 |
| cut, wash | | |
| blanched with 250 ppm phytate + | | |
| 1000 ppm CaCl₂ + pH 3.1 with HCl | | |
| and flumed with 250 ppm phytate + | | |
| 1000 ppm CaCl₂ + pH 3.1 with HCl | | |
| fry^{b} | | |

^{a}Prepared with a commercial potato chip variety.
^{b}Chips were cut 1.5 mm thick with Hobart slicer, and then washed (about 1 min) in excess (about 20:1) water at ambient temperature (about 21° C.). After removing and draining, the chips were fried at about 180° C. (355° F.) in food service partially hydrogenated vegetable oil until steam bubbles ceased (about 2 min).

TABLE 5

| | Acrylamide | Reduction |
|---|---|---|
| Potato Chip | Concentration | (% versus |
| Sample^{a} Treatment | (μg/kg; ppb) | Untreated) |
| Untreated Control | 317 | — |
| cut, wash and fry^{b} | | |
| Treated | 211 | 33 |
| cut, wash | | |
| blanched with 5% NaCl for 1 min | | |
| at 70° C. | | |
| fry^{b} | | |
| Treated | 37 | 88 |
| cut, wash | | |
| blanched with 5% NaCl for 1 min | | |
| at 70° C. | | |
| Cool 1 min in 21° C. water, then | | |
| soak in 1000 ppm chitosan solution for | | |
| 3 min at 50° C. | | |
| fry^{b} | | |

^{a}Prepared with a commercial potato chip variety.
^{b}Chips were cut 1.5 mm thick with Hobart slicer, and then washed (about 1 min) in excess (about 20:1) water at ambient temperature (about 21° C.). After removing and draining, the chips were fried at about 180° C. (355° F.) in food service partially hydrogenated vegetable oil until steam bubbles ceased (about 2 min).

TABLE 6

| | Acrylamide | Reduction |
|---|---|---|
| Potato Chip | Concentration | (% versus |
| Sample^{a} Treatment | (μg/kg; ppb) | Untreated) |
| Untreated Control | 840 | — |
| cut, wash & fry^{b} | | |
| Treated | 263 | 69 |
| cut, wash | | |
| blanched with 1000 ppm chitosan + | | |
| 1000 ppm CaCl₂ + pH 3.6 with HCl | | |
| and flumed with 1000 ppm chitosan + | | |
| 1000 ppm CaCl₂ + pH 3.6 | | |
| fry^{b} | | |

^{a}Prepared with a commercial potato chip variety.
^{b}Chips were cut 1.5 mm thick with Hobart slicer, and then washed (about 1 min) in excess (about 20:1) water at ambient temperature (about 21° C.). After removing and draining, the chips were fried at about 180° C. (355° F.) in food service partially hydrogenated vegetable oil until steam bubbles ceased (about 2 min).

### EXAMPLE 3

### Reducing Acrylamide Formation in French Fries

General procedure for making French fries—Potatoes (commercial chip potato variety, industrial source) were peeled and cut into 0.8×0.8×10 cm strips. The potato strips were rinsed in water, then blanched at 80° C. for 4 minutes in water (control) or indicated solutions, or at 70° C. for 30 minutes in water (control) or indicated solutions, and then drip-drained. Blanched strips were then flumed (immersed) in distilled water or indicated solutions for 3 minutes at about 21° C. The flumed strips were drained and excess water was then removed by forced ambient air draft. Next, the potato strips were par-fried at 190° C. for 30 seconds in commercial partially hydrogenated vegetable oil. Par-fries were then frozen at −12° C. and held. Finished French fries were prepared by frying at about 190° C. for 1.75 minutes in commercial partially hydrogenated vegetable oil. Any variation from the procedure described here are indicated in the tables.

Results—Table 7 shows that treating cut potatoes with CaCl₂ and NaCl before frying under the conditions provided in the present invention reduced acrylamide level in French fries.

Table 8 shows that including SAPP and NaCl in either the blanching or fluming solution led to a decrease in acrylamide level in French fries. Further, water-blanching cut potatoes before frying under the conditions provided in the present invention reduced acrylamide level in French fries.

Table 9 shows that including CaCl₂ and phytate in both the blanching and fluming solutions led to a decrease in acrylamide level in French fries.

TABLE 7

| | Acrylamide | Reduction |
|---|---|---|
| French Fried Potato | Concentration | (% versus |
| Sample^{a} Treatment | (μg/kg; ppb) | Untreated) |
| Untreated | 1045 | — |
| cut, and wash | | |
| finish fry^{b} immediately | | |
| Treated (typical current industry | 405 | 61 |
| practice) | | |
| cut, wash, blanch at 80° C. (about | | |
| 175° F.) in tapwater for 4 min, drain | | |
| finish fry immediately | | |
| Treated | 38 | 96 |
| cut and wash, then after washing, | | |
| 2 min tempering at 70° C. in tapwater, | | |
| then held at 70° C. in 1000 ppm CaCl₂ + | | |
| 1.5% NaCl for 30 min; then rinse | | |
| with ambient (21° C.) deionized water | | |
| for about 20 sec, drain | | |
| finish fry immediately | | |
| Treated | 55 | 95 |
| cut & wash, then after washing, 2 | | |
| min tempering at 70° C. in tapwater, | | |
| then held at 70° C. in 1000 ppm CaCl₂ + | | |
| 1.5% NaCl for 30 min; then rinse | | |
| with ambient (21° C.) deionized water | | |
| for about 20 sec, drain, par-fry at | | |
| 190° C. for 30 sec, and freeze (−20° C.) | | |
| for 12 hr | | |
| finish fry directly from freezer | | |

^{a}Prepared with a commercial french fry potato variety.
^{b}Potatoes were peeled, rinsed in tapwater, and then were cut into strips (8 × 8 × 100 mm) using a hand-operated metal French fry pressure-force cutter. After the processing or handling indicated for each sample, the potato strips were finish fried at about 190° C. (375° F.) in food service partially hydrogenated vegetable oil for 1.75 min.

TABLE 8

| | Acrylamide | Reduction |
|---|---|---|
| French Fried Potato | Concentration | (% versus |
| Sample^{a} Treatment | (μg/kg; ppb) | Untreated) |
| Untreated Control | 489 | — |
| cut, and wash | | |
| finish fry^{b} immediately | | |
| Treated (representative current | 141 | 71 |
| industry practice) | | |
| cut, wash, blanch at 80° C. (about | | |
| 175° F.) in tapwater for 4 min; flume in | | |
| 1.5% NaCl + 0.5% SAPP at 21° C. for 3 | | |
| min; drain and blow dry 3 min; par-fry | | |
| at about 190° C. (375° F.) for 30 sec; | | |
| freeze at −20° C. for 4 hr; finish fry at | | |
| about 190° C. (375° F.) for 1 min 45 sec | | |
| (1.75 min) | | |
| Treated | 62 | 87 |
| cut, wash, blanch at 70° C. (about | | |
| 158° F.) in 1.5% NaCl + 0.5% SAPP for | | |
| 30 min; flume in tapwater at 21° C. for | | |
| 3 min; drain and blow dry 3 min; par- | | |
| fry at about 190° C. (375° F.) for 30 sec; | | |
| freeze at −20° C. for 4 hr; finish fry at | | |
| about 190° C. (375° F.) for 1 min 45 sec | | |
| (1.75 min) | | |
| Treated | 30 | 95 |
| cut, wash, blanch at 70° C. (about | | |
| 175° F.) in tapwater for 30 min; flume | | |
| in 1.5% NaCl + 0.5% SAPP at 21° C. | | |
| for 3 min; drain & blow dry 3 min; | | |
| par-fry at about 190° C. (375° F.) for 30 | | |
| sec; freeze at −20° C. for 4 hr; finish fry | | |
| at about 190° C. (375° F.) for 1 min 45 | | |
| sec (1.75 min) | | |

^{a}Prepared with a commercial french fry potato variety.
^{b}Potatoes were peeled, rinsed in tapwater, and then were cut into strips (8 × 8 × 100 mm) using a hand-operated metal French fry pressure-force cutter. After the processing or handling indicated for each sample, the potato strips were finish fried at about 190° C. (375° F.) in food service partially hydrogenated vegetable oil for 1.75 min.

TABLE 9

| | Acrylamide | Reduction |
|---|---|---|
| French Fried Potato | Concentration | (% versus |
| Sample^{a Treatment} | (μg/kg; ppb) | Untreated) |
| Untreated | 560 | — |
| Basic 80° C. blanch process | | |
| Treated | 202 | 64 |
| Basic 80° C. blanch process in | | |
| 250 ppm phytate + 1000 ppm | | |
| CaCl₂ + pH 3.0 with HCl | | |
| solution and flume in 250 ppm | | |
| phytate + 1000 ppm | | |
| CaCl₂ + pH 3.0 with HCl | | |

^{a}Prepared with a commercial French fry potato variety.

### EXAMPLE 4

### Inhibition of Acrylamide Formation from Glucose and Asparagine

Model Fried System—This model was fabricated in a manner such as to generally simulate the geometry and features of a French fried potato strip. The model was constructed from glass fiber sample pads (sheets, 98×103 mm, polymer free; product #200150, CEM Corp, Matthews, N.C.). The fiber glass sheets were first cut into strips (13 mm wide×50 mm long). Then sufficient individual strips were stacked and tied twice with tight-twist cotton string to yield stacked glass fiber pad bundles with dimensions of 10 mm×13 mm×50 mm (tare wt about 1 g). Glass fiber pad bundles were then nearly saturated with desired test solutions and added solution weights were determined by difference. A standard aqueous solution consisting of 10 mM glucose+10 mM asparagine for generating acrylamide was employed, and other treatment ingredients were incorporated into the base test solution as indicated. Calculations for quantitation of acrylamide were based on weights of test solutions in glass fiber pad bundles. Weighed stacked glass pad bundles saturated with appropriate test solutions were fried at about 204° C. (400° F.) in food service partially hydrogenated vegetable oil for 0.75 min (45 sec).

Results—Table 10 shows that carbonyl group blockers cystein and N-acetylcystein inhibited acrylamide formation from glucose and asparagine.

Table 11 shows that sodium alginate inhibited acrylamide formation from glucose and asparagine.

TABLE 10

| | | Reduction |
|---|---|---|
| Stacked Glass-Pad | Acrylamide Concentration | (% versus |
| Sample Treatment | (μg/kg; ppb) | Untreated) |
| Untreated: + 10 | 655 | — |
| mM each glucose | | |
| and asparagine | | |
| fried (225° C.) | | |
| Treated + 10 | 325 | 50 |
| mM each glucose | | |
| and asparagine + 250 | | |
| ppm N-acetylcysteine | | |
| fried | | |
| Treated + 10 | 50 | 92 |
| mM each glucose | | |
| and asparagine + 2500 | | |
| ppm N-acetylcysteine | | |
| fried | | |
| Treated + 10 | 69 | 89 |
| mM each glucose | | |
| and asparagine + 2500 | | |
| ppm cysteine | | |
| fried | | |

TABLE 11

| | | Reduction |
|---|---|---|
| Stacked Glass-Pad | Acrylamide Concentration | (% versus |
| Sample Treatment | (μg/kg; ppb) | Untreated) |
| Untreated: | | |
| +10 mM each | 368 | — |
| glucose and asparagine | | |
| -fried | | |
| Treated | 291 | 21 |
| +10 mM each glucose | | |
| and asparagine + 0.1% | | |
| (1000 ppm) Na alginate | | |
| -fried | | |
| Treated | 146 | 60 |
| +10 mM each | | |
| glucose and asparagine | | |
| +0.5% (5000 ppm) Na | | |
| alginate | | |
| -fried | | |
| Treated | 50 | 86 |
| +10 mM each | | |
| glucose and asparagine | | |
| +1.0% (10,000 ppm) Na | | |
| alginate | | |
| -fried | | |

The present invention is not intended to be limited to the foregoing examples, but to encompass all such modifications and variations as come within the scope of the appended claims.

We claim:

1. A method for preparing a food material having essentially intact cellular and tissue structures for high temperature processing in order to reduce acrylamide formation during subsequent high temperature processing, the method comprising the step of:
blanching the food material in water at a temperature from about 45° C. to about 78° C. for over 4 minutes.

2. The method of claim 1, wherein the food material is blanched at a temperature from about 60° C. to about 75° C.

3. The method of claim 1, wherein the food material is blanched for about 5 minutes to about 120 minutes.

4. The method of claim 1, wherein the food material is blanched for about 10 minutes to about 90 minutes.

5. The method of claim 1, wherein the food material is cut potatoes.

6. A method for preparing a food material for high temperature processing, the method comprising the step of:
exposing the food material to an acrylamide-formation suppressing agent in an amount effective to reduce acrylamide formation in a subsequent high temperature processing step wherein the agent is selected from the group consisting of a multivalent cation, a chelating compound, a carbonyl group blocker, and a combination of any of the foregoing.

7. The method of claim 6, wherein the multivalent cation is selected from the group consisting of a calcium cation, a magnesium cation, an aluminum cation, an iron cation and a barium cation.

8. The method of claim 2, wherein the chelating compound is selected from the group consisting of phytate, phytic acid, pectin, pectate, pectic acid, pectinate, pectinic acid, alginate, alginic acid, EDTA, citric acid, and condensed phosphates.

9. The method of claim 8, wherein the chelating compound is selected from the group consisting of phytate, phytic acid, pectin, pectate, pectic acid, pectinate, pectinic acid, alginate, and alginic acid.

10. The method of claim 6, wherein the carbonyl group blocker is selected from the group consisting of lysine, cystein, and acetylcystein.

11. The method of claim 6, wherein the carbonyl group blocker is chitosan.

12. The method of claim 6, wherein the acrylamide-formation suppressing agent is a combination of any two of the substances selected from the group consisting of a multivalent cation, a chelating compound, and a carbonyl group blocker.

13. The method of claim 12, wherein the acrylamide-formation suppressing agent is a composition comprising a multivalent cation, a chelating compound, and a carbonyl group blocker.

14. The method of claim 6, wherein the acrylamide-formation suppressing agent is provided in a solution.

15. The method of claim 14, wherein the food material is exposed to the acrylamid-formation suppressing agent at a temperature from about 45° C. to about 78° C.

16. The method of claim 14, wherein the food material is exposed to the acrylamid-formation suppressing agent at a temperature from about 60° C. to about 75° C.

17. The method of claim 14, wherein the solution has a pH value from about 1.8 to about 6.8.

18. The method of claim 14, wherein the solution has a pH value from about 2.2 to about 6.5.

19. The method of claim 14, wherein the solution has a pH value from about 2.75 to about 5.5.

20. The method of claim 14, wherein the composition further comprises NaCl.

21. The method of claim 14, wherein the food material is selected from the group consisting of peeled and cut potato, and peeled and cut sweet potatoes.

22. The method of claim 21, wherein the food material is peeled and cut potato to be par-fired for making French fries and the exposing step is combined with a blanching step, a fluming step or both.

23. The method of claim 6, wherein the food material is selected from the group consisting of potato-based dough, potato-based batter, potato-based mash, grain-based dough, grain-based batter, grain-based mash.

24. The method of claim 23, wherein the acrylamide-formation suppressing agent is provided in solid form and mixed with the food material.

25. A method for making a food product from a food material, the method comprising the step of:
blanching the food material in water at a temperature from about 45° C. to about 78° C. for over 4 minutes; and
heating the food material at a high temperature.

26. A method for making a food product from a food material, the method comprising the step of:
exposing the food material to an acrylamide-formation suppressing agent in an amount effective to reduce acrylamide formation in a subsequent high temperature processing step wherein the agent is selected from the group consisting of a multivalent cation, a chelating compound, a carbonyl group blocker, and a combination of any of the foregoing; and
heating the food material at a high temperature.

27. A food material that has been treated according to the method of claim 1.

28. A food material that has been treated according to the method of claim 6.

29. A food product made according to the method of claim 25.

30. A food product made according to the method of claim 26.
